(19) United States
(12) Patent Application Publication
(10) Pub. No.: US 2026/0309679 A1
(43) Pub. Date: Oct. 8, 2026

(54) Robotic Signature Analysis (RSA)

(71) Applicant: Ralph Pinson, Anniston, AL (US)

(72) Inventor: Ralph Pinson, Anniston, AL (US)

(21) Appl. No.: 19/485,619

(22) PCT Filed: May 10, 2024
(86) PCT No.: PCT/US2024/028863

§ 371 Date: Nov. 18, 2025

Related U.S. Application Data
(60) Provisional application No. 63/504,066, filed on May 24, 2023.

(51) Int. Cl. G01N 29/44; B25J 9/16; G01N 29/036

(52) U.S. Cl. CPC G01N 29/4454; B25J 9/1674; G01N 29/036; G01N 2291/02416

(57) ABSTRACT

A method comprises: receiving a first waveform that is based on sensing of a robot using a wireless sensor, wherein the first waveform indicates a first acceleration over a first period of time; determining whether a first value of a first peak of the first waveform exceeds a first threshold; determining whether the first waveform exhibits a first vibration signature; and performing, when the first value exceeds the first threshold or when the first waveform exhibits the first vibration signature, a predictive maintenance analysis of the robot.

### CROSS-REFERENCE TO RELATED APPLICATIONS

This claims priority to U.S. Prov. Patent App. No. 63/504,066 filed on May 24, 2023, which is incorporated by reference.

### BACKGROUND

Robots provide reliable, repeatable, accurate, and cost-effective production of goods in automotive, pharmaceutical, and other industries. Robots can perform tasks that are too dangerous or repetitive for workers to perform. Such tasks include welding, parts handling, sealing, and painting in the automotive industry. For those reasons, robots continue to increase in prevalence on manufacturing lines.

Manufacturers often run manufacturing lines on strict timelines that allot time windows for robot training, production, maintenance, and downtime. Robot functionality and precision can degrade over time, and robots can fail altogether, even with a preventative maintenance program in place. When robot functionality and precision degrade, the robots may create low-quality parts or even ruin parts. When robots fail, their manufacturing lines fail and the manufacturers may not be able to fully use the time windows for robot production.

Robot degradation and failure result in lost production and thus lost revenue, as well as increased maintenance costs. The lost revenue may exceed thousands of dollars per minute. Even with quick diagnostics, robot repair may cause several hours of downtime. In addition, when workers quickly perform reactive jobs associated with robot failure instead of normally performing planned jobs, worker safety and productivity may suffer. Studies suggest that planned jobs are 75% more efficient than reactive jobs. It is therefore desirable to avoid such lost production, lost revenue, and increased maintenance costs.

### SUMMARY

In a first embodiment, a method comprises: receiving a first waveform that is based on sensing of a robot using a wireless sensor, wherein the first waveform indicates a first acceleration over a first period of time; determining whether a first value of a first peak of the first waveform exceeds a first threshold; determining whether the first waveform exhibits a first vibration signature; and performing, when the first value exceeds the first threshold or when the first waveform exhibits the first vibration signature, a predictive maintenance analysis of the robot. The first embodiment may include any combination of the following: The wireless sensor is an accelerometer. The method further comprises placing the wireless sensor on a joint of the robot. The method further comprises placing the wireless sensor proximate to a reducer of the robot. The method further comprises obtaining the first waveform using the wireless sensor. The method further comprises further obtaining the first waveform while the robot is operating. The method further comprises further obtaining the first waveform while the robot is in a production cycle. The method further comprises wirelessly transmitting the first waveform from the wireless sensor to a gateway. The method further comprises transmitting the first waveform from the gateway to a network. The method further comprises further receiving the first waveform from the network. The first period is based on a production cycle of the robot. The first period is about 55 s. The first value does not exceed the first threshold, and the method further comprises: skipping determining whether the first waveform exhibits the first vibration signature; receiving, after skipping determining whether the first waveform exhibits the first vibration signature, a second waveform that is based on sensing of the robot using the wireless sensor, wherein the second waveform indicates a second acceleration over a second period of time; determining whether a second value of a second peak of the second waveform exceeds the first threshold; determining, when the second value exceeds the first threshold, whether the second waveform exhibits a second vibration signature; and performing, when the second waveform exhibits the second vibration signature, the predictive maintenance analysis of the robot. The method further comprises further determining whether the first waveform exhibits the first vibration signature based on a peak value exceeding a second threshold, a PTP value of the first waveform exceeding a third threshold, an average of values in a valley between peaks of the first waveform exceeding a fourth threshold, or the first waveform comprising pulses. The method further comprises further performing the predictive maintenance analysis by: obtaining grease from a component that is of the robot and that is associated with the first waveform; and measuring metal PPM in the grease. The method further comprises: repeating the obtaining and the measuring until the metal PPM exceeds a second threshold; and refurbishing or replacing the component when the metal PPM exceeds the second threshold. The method further comprises further repeating the obtaining and the measuring on a schedule. When the first waveform does not exhibit the first vibration signature, the method further comprises: skipping performing the predictive maintenance analysis; receiving, after skipping performing the predictive maintenance analysis, a second waveform that is based on sensing of the robot using the wireless sensor, wherein the second waveform indicates second acceleration over a second period of time; determining whether a second value of a second peak of the second waveform exceeds the first threshold; determining, when the second value exceeds the first threshold, whether the second waveform exhibits a second vibration signature; and performing, when the second waveform exhibits the second vibration signature, the predictive maintenance analysis of the robot.

In a second embodiment, an apparatus comprises: a memory configured to store instructions; and a processor coupled to the memory and configured to execute the instructions to cause the apparatus to: receive a first waveform that is based on sensing of a robot using a wireless sensor, wherein the first waveform indicates first acceleration over a first period of time; determine whether a first value of a first peak of the first waveform exceeds a first threshold; determine whether the first waveform exhibits a first vibration signature; and display, when the first value exceeds the first threshold or when the first waveform exhibits the first vibration signature, a prompt to perform a predictive maintenance analysis of the robot.

In a third embodiment, a computer program product comprises instructions that are stored on a computer-readable medium and that, when executed by a processor, cause an apparatus to: receive a first waveform that is based on sensing of a robot using a wireless sensor, wherein the first waveform indicates first acceleration over a first period of time; determine whether a first value of a first peak of the first waveform exceeds a first threshold; determine whether the first waveform exhibits a first vibration signature; and display, when the first value exceeds the first threshold or when the first waveform exhibits the first vibration signature, a prompt to perform a predictive maintenance analysis of the robot.

Any of the above embodiments may be combined with any of the other above embodiments to create a new embodiment. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an RSA system.

FIG. 2 is a schematic diagram of a robot.

FIG. 3A is a picture of a reducer.

FIG. 3B is a picture of a bearing and shaft system from the reducer in FIG. 3A.

FIG. 3C is a picture of the shaft in the bearing and shaft system in FIG. 3B.

FIGS. 4A-4C are flowcharts of a method of RSA.

FIG. 5 is a graph of a waveform.

FIG. 6 is a graph of another waveform.

FIG. 7 is a graph of yet another waveform.

FIG. 8 is a graph of yet another waveform.

FIG. 9 is a flowchart of a simplified method of RSA.

FIG. 10 is a schematic diagram of an apparatus.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following abbreviations apply:
ASIC: application-specific integrated circuit
CPU: central processing unit
DSP: digital signal processor
EO: electrical-to-optical
FANUC: Fuji Automatic Numerical Control
FFT: fast Fourier transform
FPGA: field-programmable gate array
g: standard acceleration due to gravity
IR: infrared
OE: optical-to-electrical
PPM: part(s) per million
PTP: peak-to-peak
RAM: random-access memory
RF: radio frequency
ROM: read-only memory
RSA: robotic signature analysis
RX: receiver unit
s: second(s)
SRAM: static RAM
TCAM: ternary content-addressable memory
TX: transmitter unit
VFD: variable-frequency drive
°: degree(s)
%: percent.

Manufacturing line robots have many components, such as motors, pumps, fans, and compressors, that become faulty due to normal wear and tear, design defects, and manufacturing defects. Some manufacturers perform scheduled preventative maintenance by replacing components at specified intervals. However, such preventative maintenance risks replacing parts that are not failing and thus unnecessarily expending costs. In addition, preventative maintenance cannot predict failures that occur before component replacement.

Other manufacturers perform predictive maintenance analyses on electronic components using IR cameras and on mechanical components using ultrasonic detectors. However, such analyses do not predict failures early enough or accurately. Predicting failures late may allow for degradation of robot functionality and precision. In addition, IR cameras and ultrasonic detectors are very expensive. Furthermore, IR and ultrasonic data must be taken over long periods of time and then compared to determine trends, and thus consume significant employee time.

Yet other manufactures perform maintenance analyses using grease samples. However, such analyses are usually reactive and do not predict failures early enough. For instance, manufacturers often begin such analyses when components become noisy or robots become imprecise. This often results in having to reteach robots or in predicting failures only a few hours ahead of time, the latter of which risks catastrophic failure. Replacing components late leads to impromptu planning, expediting new component ordering, risking that components are on backorder, an inability to analyze failures, and reworking of poorly-performed jobs, all of which can significantly extend downtime. In addition, obtaining grease samples consumes significant employee time.

In short, current approaches to predicting failures are too costly, inaccurate, reactive, and time-intensive. It is therefore desirable to predict failures more economically, accurately, proactively, and timely. Such improvements would permit more time to plan, more time to order components, needing fewer components on site, less-costly repairs, more time to analyze failures, and minimal reworking, thus yielding fewer or no manufacturing lines failures and yielding increased productivity and improved safety.

More specifically, bearings are critical parts of rotating components, making bearing fault diagnosis and prediction based on signals a long-researched issue. Bearing signals are normally non-linear and unstable, and thus difficult to analyze in the time domain or frequency domain only. Meanwhile, as discussed in Jie Wu, et al., “Self-Adaptive Spectrum Analysis Based Bearing Fault Diagnosis,” Sensors, Volume 18, Issue 10, Oct. 2, 2018, which is incorporated by reference, fault feature vectors extracted conventionally with fixed dimensions may cause insufficiency or redundancy of diagnostic information and result in poor diagnostic performance. Huanqing Han, et al., “Vibration Analysis Based Condition Monitoring for Industrial Robots,” Mechanisms and Machine Science, Volume 105, May 16, 2021, which is incorporated by reference, demonstrates similar difficulties with current approaches. There is therefore a need to better predict and diagnose bearing faults.

Disclosed herein are embodiments for RSA. RSA receives acceleration time waveforms from wireless sensors on robots and may do so while the robots are running. RSA employs a vibration analysis of the waveforms to predict robot component failure. The vibration analysis compares the waveforms to parameters that are based on a library of vibration signatures. The waveforms do not require significant time or trending and can detect failures more than six months before they occur. The vibration analysis is not an intuitive solution because the robot components that often fail do not rotate 360°, continuously, or at known speeds. In addition, robots have many motors and gearboxes that run at the same time and perform different tasks. However, RSA proves that vibration analysis is most effective for predicting failures in rotating components such as reducers, which may also be referred to as gearboxes. Not only does RSA predict failures with up to 100% accuracy, it also predicts failures at least five months ahead of time. Five months allows plenty of time for manufacturers to plan, schedule, and safely conduct repairs. With such high accuracy and early detection, RSA can save manufacturers millions of dollars just on single manufacturing lines by ensuring no undesired downtime. In addition, wireless sensors cost significantly less than IR cameras and other diagnostic tools. While reducers are discussed, the embodiments apply to other rotating robot components, non-rotating robot components, and non-robot components. Such other components include servo motors, VFDs, and servo amplifiers.

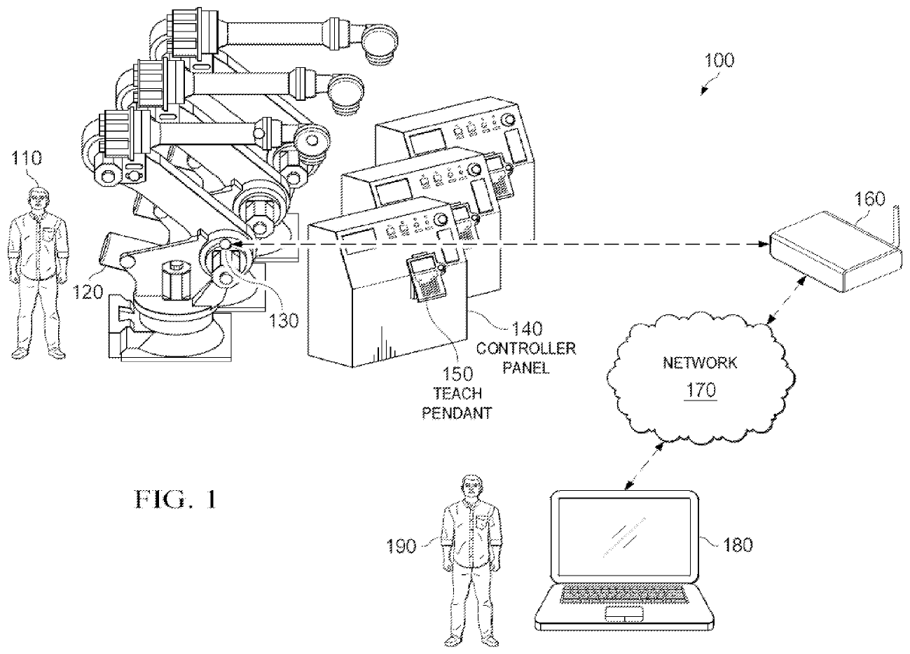

FIG. 1 is a schematic diagram of an RSA system 100. The RSA system 100 comprises an operator 110, robots 120, wireless sensors 130, a control panel 140, a teach pendant 150, a gateway 160, a network 170, a terminal device 180, and an analyzer 190. The wireless sensors 130 and the gateway 160 are communicatively coupled to each other, the gateway 160 and the network 170 are communicatively coupled to each other, and the network and the terminal device 180 are communicatively coupled to each other. The wireless sensors 130 may be accelerometers and may instead be wired sensors. The gateway 160 may be a digital gateway. The network 170 may be the internet or another suitable network. The terminal device 180 may comprise software that performs functions described below.

In operation, the operator 110 teaches the robots 120 with the teach pendant 150 and operates the robots 120 with the control panel 140. The robots 120 run production cycles, or work programs, to perform manufacturing duties such as welding for automobile parts. A production cycle is the process in which a robot completes a single job before repeating that job. The job may be welding two components together or painting a panel. While the robots 120 run the production cycles or at other suitable times, the wireless sensors 130 collect data and wirelessly transmit the data to the gateway 160. The gateway 160 transmits the data to the terminal device 180 via the network 170. The analyzer 190 analyzes the data using the terminal device 180.

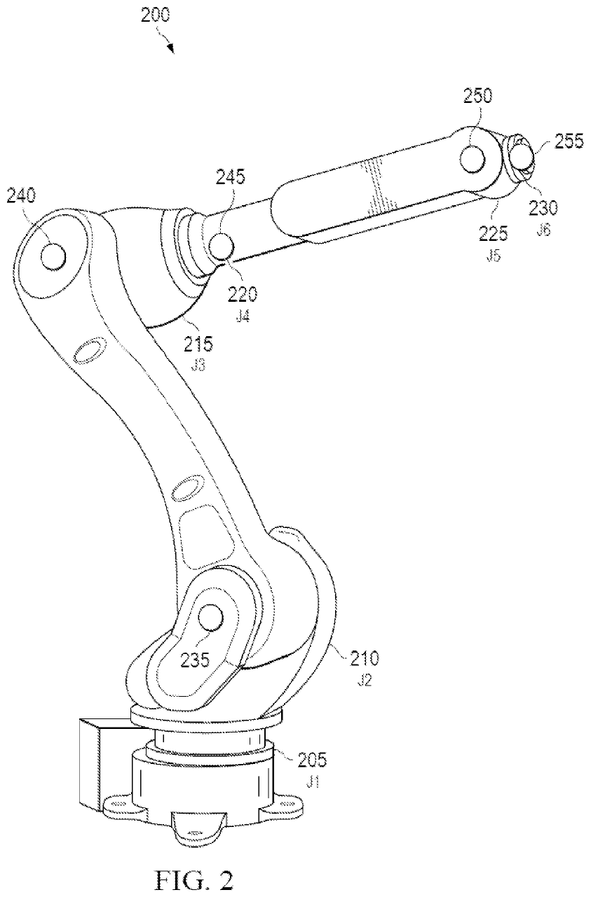

FIG. 2 is a schematic diagram of a robot 200. The robot 200 may implement the robots 120 in FIG. 1. The robot 200 comprises joints J1 205, J2 210, J3 215, J4 220, J5 225, and J6 230 and comprises wireless sensors 235, 240, 245, 250, 255. While FIG. 2 shows that the robot 200 comprises six joints 205-230 and five wireless sensors 235-255, the robot 200 may comprise fewer or more joints and wireless sensors in the same or different locations. Alternatively, the wireless sensors 235-255 are wired sensors.

J1 205 rotates on a first axis to rotate a body of the robot 200. J2 210 rotates on a second axis to move a lower arm of the robot 200 backward and forward. J3 215 rotates on a third axis to move an upper arm of the robot 200 up and down. J4 220 rotates on a fourth axis to rotate the upper arm. J5 225 rotates on a fifth axis to move a wrist of the robot 200 upward and downward. J6 230 rotates on a sixth axis to rotate the wrist in a circular motion.

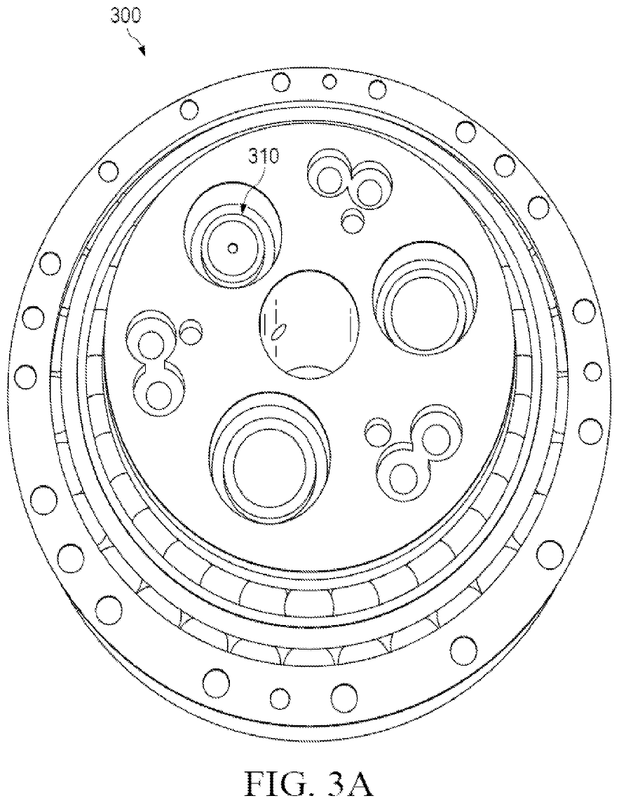

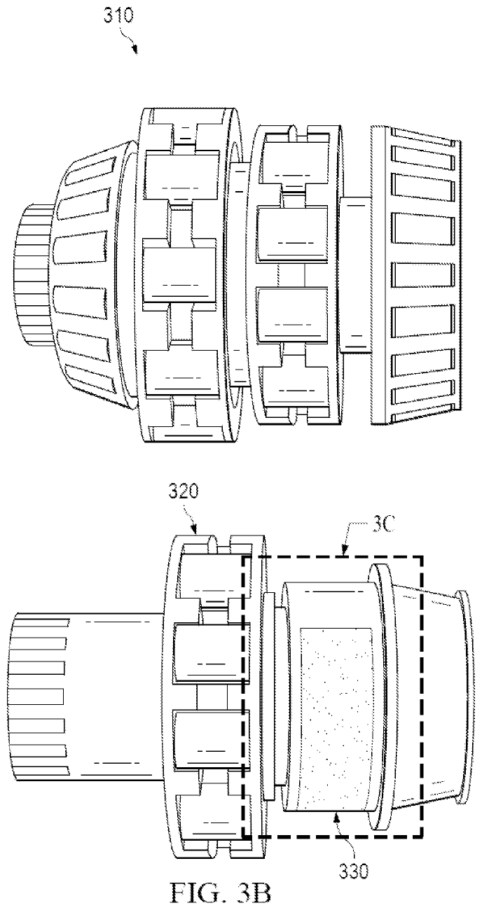

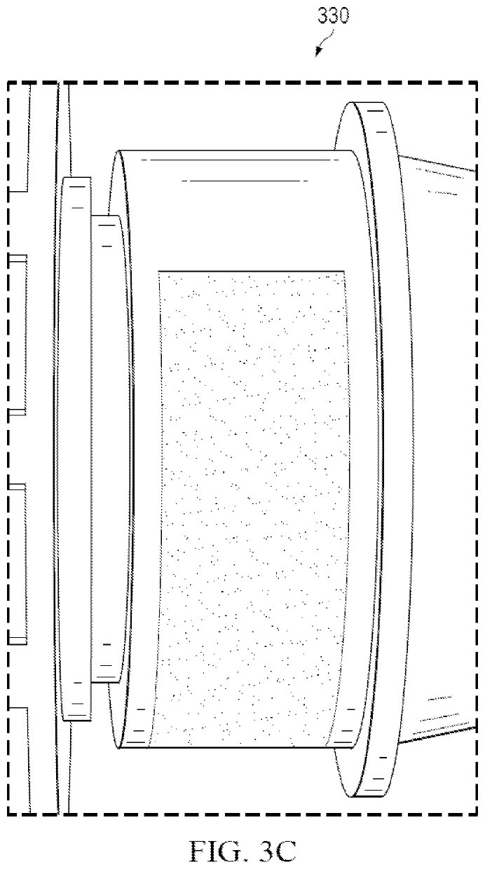

The wireless sensor 235 is positioned on J2 210 or proximate to a reducer inside the robot 200 and associated with J2 210. A reducer is shown in FIGS. 3A-3C, which is discussed below. The wireless sensor 240 is positioned on J3 215 or proximate to a reducer inside the robot 200 and associated with J3 215. There wireless sensors 245 is positioned on J4 220 or proximate to a reducer inside the robot 200 and associated with J4 220. The wireless sensor 250 is positioned on J5 225 or proximate to a reducer inside the robot 200 and associated with J5 225. The wireless sensor 255 is positioned on J6 230 or proximate to a reducer inside the robot 200 and associated with J 6 230. In this context, “proximate” means within about 12 inches, 6 inches, or 1 inch.

As shown, the wireless sensors 235-255 are not placed on all of the six joints 205-230 or proximate to all of the reducers, but rather on only four joints 210, 215, 225, 230 or proximate to four reducers. Even still, the wireless sensors 235-255 are able to provide sufficient information to indicate failures of any reducers in the robot 200. Fewer or more wireless sensors may achieve a similar goal.

FIG. 3A is a picture of a reducer 300. Specifically, the reducer 300 is a FANUC planetary reducer used in 2,000-series reducers. The reducer 300 may implement the reducers discussed with respect to FIG. 2. The reducer 300 comprises three bearing and shaft systems 310. FIG. 3B is a picture of a bearing and shaft system 310 from the reducer 300 in FIG. 3A. The bearing and shaft system 310 comprises a bearing 320 and a shaft 330. The bearing 320 is a tapered roller bearing. FIG. 3B shows that the bearing 320 is failed because its surface has lost its smoothness. Reducers may fail for reasons such as sudden stops, contact with other objects while moving, blown seals due to failure to maintain grease levels or improper application of grease, or poor programming of the robot 200 that allows the reducer 300 to run beyond its operating thresholds. FIG. 3C is a picture of the shaft 330 in the bearing and shaft system 310 in FIG. 3B.

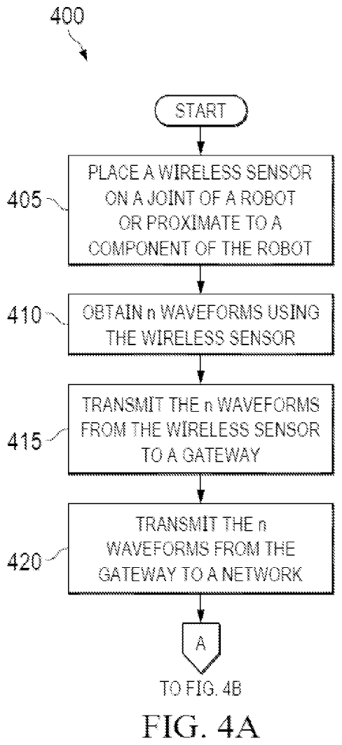

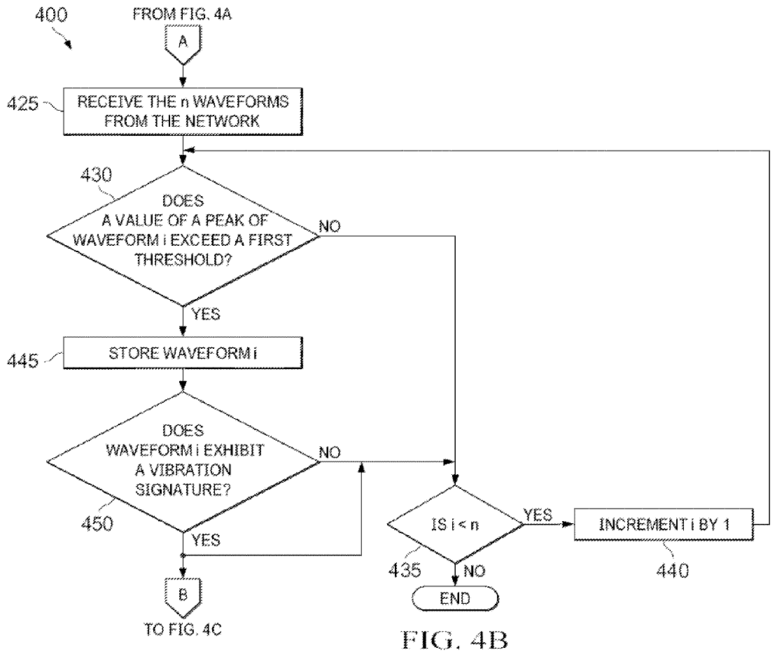

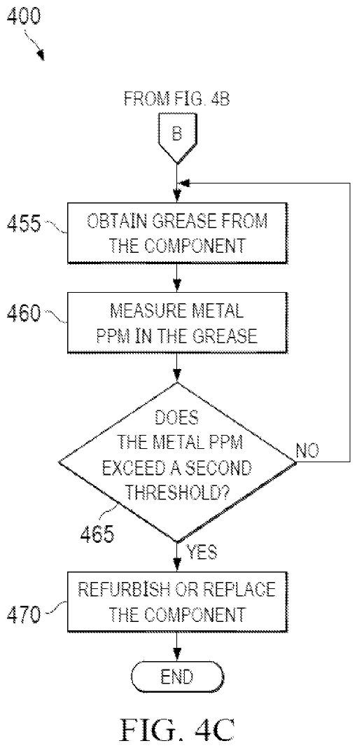

FIGS. 4A-4C are flowcharts of a method 400 of RSA. In FIG. 4A, at step 405, a wireless sensor is placed on a joint of a robot or proximate to a component of the robot. The wireless sensors may be one of the wireless sensors 235-255, the joint may be one of the joints 205-230, and the component may be the reducer 300. While one wireless sensors is discussed, the method 400 may be simultaneously performed for multiple wireless sensors, for instance, each of the wireless sensors 235-255.

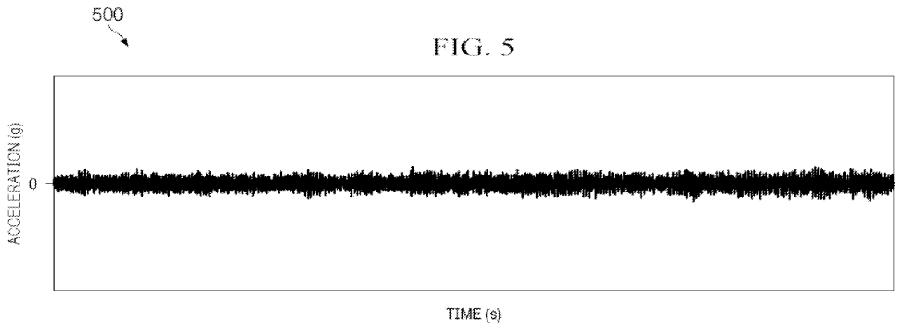

At step 410, n waveforms are obtained using the wireless sensors. n is a positive integer. The n waveforms may be taken continuously or on a schedule. The schedule may be once a day or twice a day, and for each day of the week or for weekdays. The n waveforms may be taken while the robot 200 is operating, for instance, while the robot 200 is in a production cycle. The n waveforms may be similar to what is shown in FIG. 5. The wireless sensors may be any combination of the wireless sensors 235-255.

FIG. 5 is a graph of a waveform 500. The x-axis represents time in s, and the y axis represents acceleration in g. Specifically, the x-axis is over a period of 6 s. The period may be based on a production cycle of the robot 200 in order to observe different indications of component failure that may occur during different operations of the robot 200 in the production cycle. The production cycle may be about 55 s. While the x-axis is in s, the x-axis may be in other suitable units of time. While the y-axis is in g, the y-axis may be in other suitable units of acceleration.

As shown, the waveform 500 exhibits a substantially consistent acceleration across the entire 6 s. For instance, the waveform 500 does not exhibit peak values above known thresholds, PTP values above known thresholds, or averages of values that are in valleys between peaks and that are above known thresholds. Thus, the waveform 500 suggests that the reducer 300 is functioning well.

Other analyses may use frequency-based waveforms, for instance, by applying an FFT to the waveform 500 or by applying an FFT to a velocity measurement. However, because reducers have so many components and those components run at different speeds, frequency-based waveforms cannot show single issues due to single components. Also, velocity measurements do not provide data that are helpful enough.

Returning to FIG. 4A, at step 415, the n waveforms are transmitted from the wireless sensor to a gateway. The gateway may be the gateway 160.

At step 420, the n waveforms are transmitted from the gateway to a network. The network may be the network 170.

In FIG. 4B, at step 425, the n waveforms are received from the network. The terminal device 180 may receive the n waveforms.

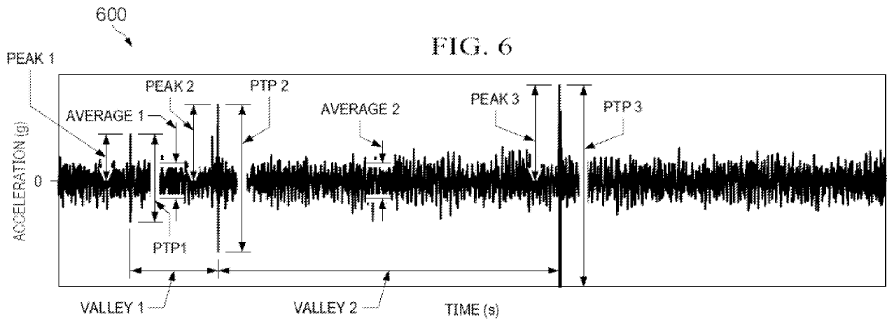

At decision 430, it is determined whether a value of a peak of waveform i exceeds a first threshold. The software on the terminal device 180 or the analyzer 190 may make the determination. The peak may be similar to what is shown in FIG. 6. The first threshold may be predetermined so that it is known before the method 400 begins or before decision 430 occurs. The analyzer 190 may store the first threshold in the terminal device 180 before such time. If the answer to decision 430 is no, then the method 400 skips step 445 and decision 450 and proceeds to decision 435. If the answer to decision 430 is yes, then the method 400 proceeds to step 445.

FIG. 6 is a graph of another waveform 600. The waveform 600 is similar to the waveform 500, but occurs after a first period of time after the waveform 500. As shown, the waveform 600 comprises 3 peaks, peak 1, peak 2, and peak 3. Each of the peaks may have a value above the first threshold and thus yield an answer of yes to decision 430. As an example, the three peaks may correspond to three broken teeth in a gear assembly of the reducer 300. Thus, unlike the waveform 500, which does not comprises peaks with values above the first threshold, the waveform 600 suggests that the reducer 300 is not functioning well. The waveform 600 further comprises 3 PTPs, PTP 1, PTP 2, and PTP 3; valley 1 between peak 1 and peak 2; valley 2 between peak 2 and peak 3; average 1 in valley 1; and average 2 in the valley 2. Those characteristics are discussed further below.

Returning to FIG. 4, at decision 435, it is determined whether i<n. The software or the analyzer 190 may make the determination. i is an integer counter variable such i≤1. If the answer to decision 435 is yes, then the method 400 proceeds to step 440. If the answer to decision 435 is no, then the method 400 ends.

At step 440, i is incremented by 1. The software or the analyzer 190 may increment i. After step 440, the method 400 returns to decision 430.

At step 445, waveform i is stored. The analyzer 190 may store waveform i locally in the terminal device 180 or may store waveform i in a server and using the terminal device 180.

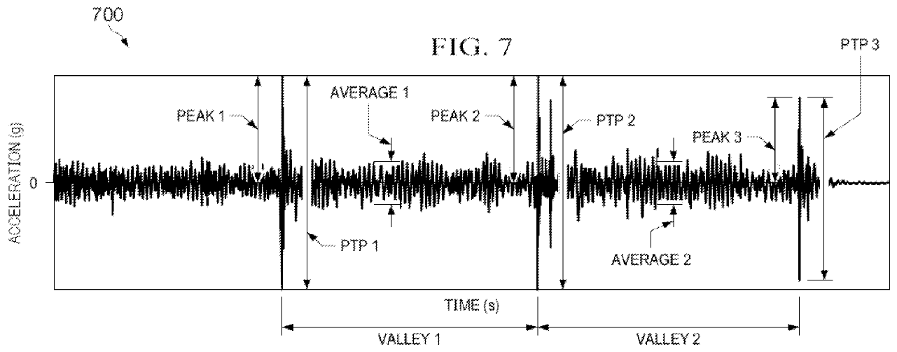

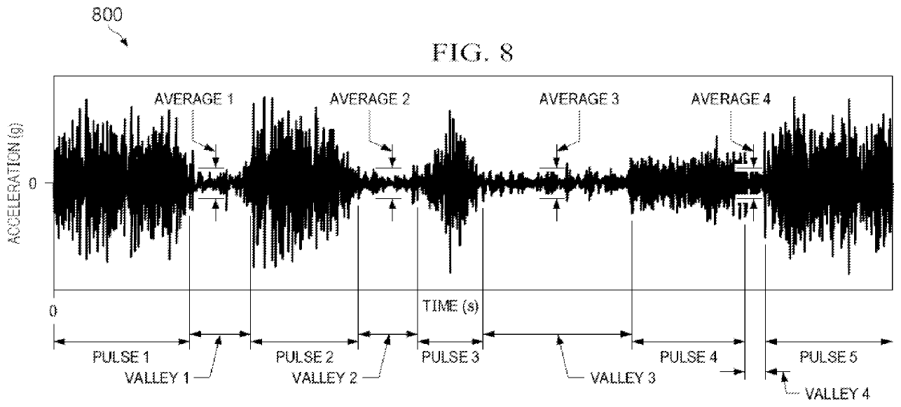

At decision 450, it is determined whether waveform i exhibits a vibration signature. The software or the analyzer 190 may make the determination based on any combination of characteristics shown in FIGS. 7-8. If the answer to decision 450 is no, then the method 400 proceeds to decision 435 skips step 455 and skips step 455. If the answer to decision 450 is yes, then the method 400 proceeds to both decision 435 and step 455, the latter to perform predictive maintenance analysis.

FIG. 7 is a graph of yet another waveform 700. The waveform 700 is similar to the waveform 600, but occurs after a second period of time after the waveform 600. However, the waveform 700 exhibits a vibration signature. First, the waveform 700 comprises 3 peaks, peak 1, peak 2, and peak 3, that have values that are even higher than those in the waveform 600. Specifically, each of the peaks may have a value above a second threshold. The second threshold may be higher than the first threshold at decision 430. Second, the waveform 700 comprises 3 PTPs, PTP 1, PTP 2, and PTP 3. Each of the PTPs may have a value above a third threshold. Third, the waveform 700 comprises a valley between peak 2 and peak 3 and an average of values in the valley. The average may have a value above a fourth threshold. The second threshold, the third threshold, and the fourth threshold may be predetermined so that they are known before the method 400 begins or before decision 430 occurs. The analyzer 190 may store the second threshold, the third threshold, and the fourth threshold in the terminal device 180 before such time. Thus, the waveform 600 suggests that the reducer 300 is functioning even less well than the reducer 300 as reflected in the waveform 500.

FIG. 8 is a graph of yet another waveform 800. The waveform 800 is similar to the waveform 800, but occurs after a third period of time after the waveform 700. However, the waveform 800 comprises 5 pulses, pulse 1, pulse 2, pulse 3, pulse 4, and pulse 5, which are groupings of peaks instead of discrete peaks. The mere presence of the pulses, but also averages of values of peaks in those pulses, both further exhibit a vibration signature. Thus, the waveform 800 suggests that the reducer 300 is function even less well than the reducer 300 as reflected in the waveform 700. The waveform 800 may suggest that the reducer 300 has failed or that failure is imminent.

Thus, any combination of characteristics shown in FIGS. 7-8 may demonstrate the vibration signature. Those characteristics comprise a peak value exceeding a second threshold, a PTP value exceeding a third threshold, an average of values in a valley between peaks exceeding a fourth threshold, or the presence of pulses. While the characteristics are discussed with respect to step 450 and FIGS. 7-8, the characteristics may also be analyzed with respect to step 430 and FIG. 6.

In FIG. 4C, at step 455, grease is obtained from the component. The operator 110 or the analyzer 190 may obtain the grease and may do so on a schedule, for instance, once a month. The grease may be from the bearing 320 or the shaft 330 of the reducer 300 in FIG. 3.

At step 460, metal PPM in the grease is measured. The operator 110 or the analyzer 190 may measure the metal PPM by inserting a tube into the component, withdrawing grease from the component using a syringe, and injecting the grease into a metal dust analyzer. The operator 110 or the analyzer 190 may measure the metal PPM on a schedule along with obtaining the grease, for instance, once a month. The metal may be iron or another metal in the component. Metal in the grease suggests components are improperly contacting each other, causing pieces of metal to file off and fall into the grease.

At decision 465, it is determined whether the metal PPM exceeds a second threshold. If the answer to decision 465 is no, then the method 400 returns to step 455. If the answer to decision 465 is yes, then the method 400 proceeds to step 470. Taken together, step 455, step 460, and decision 465 may be referred to as predictive maintenance analysis.

At step 470, the component is refurbished or replaced. The operator 110 may send the component to a manufacturer of the component or to another entity to refurbish the component, or the operator 110 may replace the component with a new one. Step 470 may be referred to as predictive maintenance. After step 470, the method 400 ends.

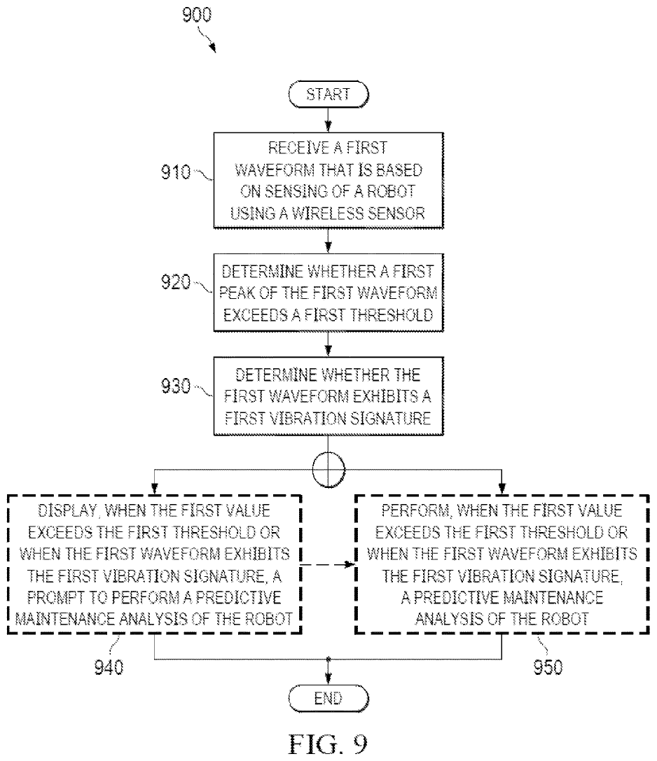

FIG. 9 is a flowchart of a simplified method 900 of RSA. At step 910, a first waveform that is based on sensing of a robot is received using a wireless sensor. The first waveform may be similar to the waveform 500, the robot may be the robot 200, and the wireless sensor may be one of the wireless sensors 235-255. At step 920, it is determined whether a first value of a first peak of the first waveform exceeds a first threshold. At step 930, it is determined whether the first waveform exhibits a first vibration signature. Alternatively, step 930 occurs when the first value exceeds the first threshold. After step 930, the simplified method 900 may proceed to step 940 or step 950. Alternatively, the simplified method 900 may proceed to step 940, then step 950. At step 940, a prompt to perform a predictive maintenance analysis of the robot is displayed when the first value exceeds the first threshold or when the first waveform exhibits the first vibration signature. At step 950, a predictive maintenance analysis of the robot is performed when the first value exceeds the first threshold or when the first waveform exhibits the first vibration signature. Alternatively, steps 940 and 950 occur when the first value exceeds the first threshold and when the first waveform exhibits the first vibration signature.

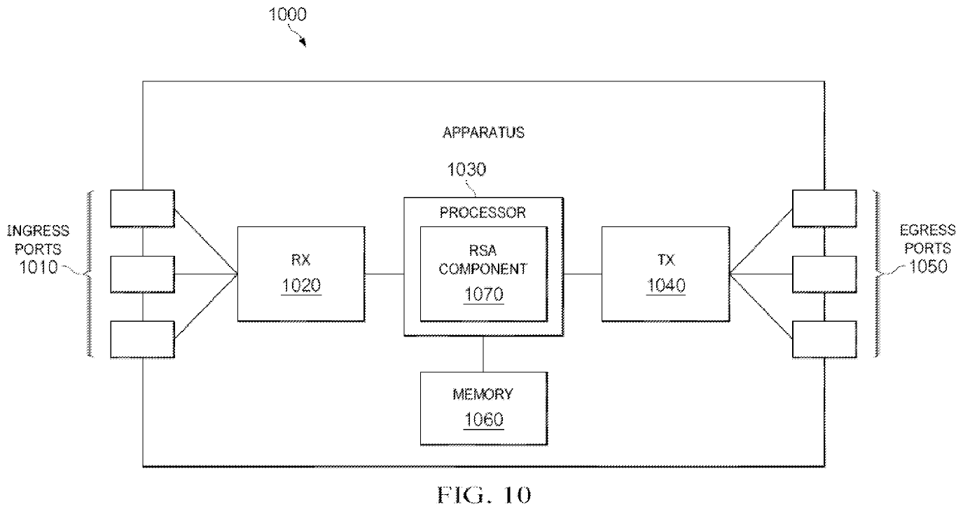

FIG. 10 is a schematic diagram of an apparatus 1000. The apparatus 1000 may implement the disclosed embodiments, for instance, the wireless sensors 130, the control panel 140, the teach pendant 150, the gateway 160, or the terminal device 180. The apparatus 1000 comprises ingress ports 1010 and an RX 1020 to receive data; a processor 1030, or logic unit, baseband unit, or CPU, to process the data; a TX 1040 and egress ports 1050 to transmit the data; and a memory 1060 to store the data. The apparatus 1000 may also comprise OE components, EO components, or RF components coupled to the ingress ports 1010, the RX 1020, the TX 1040, and the egress ports 1050 to provide ingress or egress of optical signals, electrical signals, or RF signals.

The processor 1030 is any combination of hardware, middleware, firmware, or software. The processor 1030 comprises any combination of one or more CPU chips, cores, FPGAS, ASICs, or DSPs. The processor 1030 communicates with the ingress ports 1010, the RX 1020, the TX 1040, the egress ports 1050, and the memory 1060. The processor 1030 comprises an RSA component 1070, which implements the disclosed embodiments. The inclusion of the RSA component 1070 therefore provides a substantial improvement to the functionality of the apparatus 1000 and effects a transformation of the apparatus 1000 to a different state. Alternatively, the memory 1060 stores the RSA component 1070 as instructions, and the processor 1030 executes those instructions.

The memory 1060 comprises any combination of disks, tape drives, or solid-state drives. The apparatus 1000 may use the memory 1060 as an overflow data storage device to store programs when the apparatus 1000 selects those programs for execution and to store instructions and data that the apparatus 1000 reads during execution of those programs. The memory 1060 may be volatile or non-volatile and may be any combination of ROM, RAM, TCAM, or SRAM.

A computer program product may comprise computer-executable instructions that are stored on a computer-readable medium and that, when executed by a processor, cause an apparatus to perform any of the embodiments. The non-transitory medium may be the memory 1060, the processor may be the processor 1030, and the apparatus may be the apparatus 1000.

The term “about” means a range including ±10% of the subsequent number unless otherwise stated. Where single components, apparatuses, or systems are described as performing functions, multiple such components, apparatuses, or systems may implement the functions.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method comprising:
receiving a first waveform that is based on sensing of a robot using a wireless sensor, wherein the first waveform indicates a first acceleration over a first period of time;
determining whether a first value of a first peak of the first waveform exceeds a first threshold;
determining whether the first waveform exhibits a first vibration signature; and
performing, when the first value exceeds the first threshold or when the first waveform exhibits the first vibration signature, a predictive maintenance analysis of the robot.

2. The method of claim 1, wherein the wireless sensor is an accelerometer.

3. The method of claim 1, further comprising placing the wireless sensor on a joint of the robot.

4. The method of claim 1, further comprising placing the wireless sensor proximate to a reducer of the robot.

5. The method of claim 1, further comprising obtaining the first waveform using the wireless sensor.

6. The method of claim 5, further comprising further obtaining the first waveform while the robot is operating.

7. The method of claim 5, further comprising further obtaining the first waveform while the robot is in a production cycle.

8. The method of claim 5, further comprising wirelessly transmitting the first waveform from the wireless sensor to a gateway.

9. The method of claim 8, further comprising transmitting the first waveform from the gateway to a network.

10. The method of claim 9, further comprising further receiving the first waveform from the network.

11. The method of claim 1, wherein the first period is based on a production cycle of the robot.

12. The method of claim 11, wherein the first period is about 55 seconds(s).

13. The method of claim 1, wherein when the first value does not exceed the first threshold, the method further comprises:
skipping determining whether the first waveform exhibits the first vibration signature;
receiving, after skipping determining whether the first waveform exhibits the first vibration signature, a second waveform that is based on sensing of the robot using the wireless sensor, wherein the second waveform indicates a second acceleration over a second period of time;
determining whether a second value of a second peak of the second waveform exceeds the first threshold;
determining, when the second value exceeds the first threshold, whether the second waveform exhibits a second vibration signature; and
performing, when the second waveform exhibits the second vibration signature, the predictive maintenance analysis of the robot.

14. The method of claim 1, further comprising further determining whether the first waveform exhibits the first vibration signature based on a peak value exceeding a second threshold, a peak-to-peak (PTP) value of the first waveform exceeding a third threshold, an average of values in a valley between peaks of the first waveform exceeding a fourth threshold, or the first waveform comprising pulses.

15. The method of claim 1, further comprising further performing the predictive maintenance analysis by:
obtaining grease from a component that is of the robot and that is associated with the first waveform; and
measuring metal parts per million (PPM) in the grease.

16. The method of claim 15, further comprising:
repeating the obtaining and the measuring until the metal PPM exceeds a second threshold; and
refurbishing or replacing the component when the metal PPM exceeds the second threshold.

17. The method of claim 16, further comprising further repeating the obtaining and the measuring on a schedule.

18. The method of claim 1, wherein when the first waveform does not exhibit the first vibration signature, the method further comprises:
skipping performing the predictive maintenance analysis;
receiving, after skipping performing the predictive maintenance analysis, a second waveform that is based on sensing of the robot using the wireless sensor, wherein the second waveform indicates second acceleration over a second period of time;
determining whether a second value of a second peak of the second waveform exceeds the first threshold;
determining, when the second value exceeds the first threshold, whether the second waveform exhibits a second vibration signature; and
performing, when the second waveform exhibits the second vibration signature, the predictive maintenance analysis of the robot.

19. An apparatus comprising:
a memory configured to store instructions; and
a processor coupled to the memory and configured to execute the instructions to cause the apparatus to:
receive a first waveform that is based on sensing of a robot using a wireless sensor, wherein the first waveform indicates first acceleration over a first period of time;
determine whether a first value of a first peak of the first waveform exceeds a first threshold;
determine whether the first waveform exhibits a first vibration signature; and
display, when the first value exceeds the first threshold or when the first waveform exhibits the first vibration signature, a prompt to perform a predictive maintenance analysis of the robot.

20. A computer program product comprising instructions that are stored on a computer-readable medium and that, when executed by a processor, cause an apparatus to:
receive a first waveform that is based on sensing of a robot using a wireless sensor, wherein the first waveform indicates first acceleration over a first period of time;
determine whether a first value of a first peak of the first waveform exceeds a first threshold;
determine whether the first waveform exhibits a first vibration signature; and
display, when the first value exceeds the first threshold or when the first waveform exhibits the first vibration signature, a prompt to perform a predictive maintenance analysis of the robot.
